(19) United States
(12) Patent Application Publication
(10) Pub. No.: US 2006/0096349 A1
(43) Pub. Date: May 11, 2006

(54) Method of pipette calibration

(76) Inventors: Andrzej Czernecki, Warsaw (PL); Andrzej Jankowski, Warsaw (PL); Wojciech Sarna, Warsaw (PL)

Correspondence Address: PILLSBURY WINTHROP SHAW PITTMAN LLP, 1650 TYSONS BOULEVARD, MCLEAN, VA, 22102, US

(21) Appl. No.: 10/525,236

(22) PCT Filed: Mar. 17, 2003
(86) PCT No.: PCT/PL03/00023

§ 371 Date: Oct. 11, 2005

(30) Foreign Application Priority Data
Aug. 27, 2002 (PL) P.355728
Nov. 15, 2002 (PL) P.357148

(51) Int. Cl. G01F 25/00

(52) U.S. Cl. 73/1.74

(57) ABSTRACT

In the method of pipette calibration, the volume of liquid to be aspired is manually set by turning in and out the adjustment screw regulating the length of the operational stroke of the plunger inside the shaft, the position of the adjustment screw is detected, and a signal corresponding to the position of the adjustment screw is sent to the pipette electronic system, and next the signal corresponding to the position of the adjustment screw is compared with values of points from the aspiration table or values of the aspiration function, which has been earlier input to the memory of the electronic system correspondingly as the standard aspiration table or aspiration function for the pipette, and next to the position of the adjustment screw, the value of the aspired liquid volume is assigned, and displayed on the display.

### BACKGROUND OF THE INVENTION

1. Field of the Invention

This invention relates to the method of pipette calibration.

2. Description of the Related Art

The German patent No. 43 35 863 discloses a piston pipette comprising adjustment means to change the piston stroke, indicator means to indicate the dosed volume of liquid, and coupling elements placed between the adjustment means and indicator means, for changing the pipette correction coefficient determining the ratio of piston stroke to the indicated liquid volume. The pipette comprises switching device for disconnection of the coupling means and to change the pipette correction coefficient through re-adjustment of the adjustment means. The coupling means comprise two spur gears connected with each other, whereas the adjustment means are joined with the adjustment spur gear rotated appropriately to the piston stroke, while indicator means are joined with the indicating spur gear rotated appropriately to the indicated liquid volume. One spur gear meshes with the adjustment spur gear, while the other spur gear meshes with the indicator spur gear, whereas the coupling spur gears are disposed on one axis, abut against a spring, and can be slid by the switching device along the axis in the direction opposite to the spring action at de-coupling of at least one face coupling.

The U.S. Pat. No. 4,567,780 discloses a pipette having a body comprising manually actuated plunger assembly. The pipette includes electric contacts to detect the limit plunger position, linear position sensors generating an electric signal proportional to the plunger distance from the limit position, and a converter converting these electric signals into indications of volume.

Further, the U.S. Pat. No. 5,389,341 discloses a pipette having a body with the lower and the upper end, wherein a cylinder open below the body lower end is disposed, and a piston is positioned inside the cylinder movable between the lower and the upper position to aspirate liquid into the pipette, and to dose liquid from the pipette. Known pipette moreover comprises a motor and a transmission to move the piston, an electronic control assembly to control the piston movements, a braking assembly to stop the piston movement in a pre-set position, a knob making a progressive-reciprocal and sliding movements inside the body, and the knob movement measurement assembly. The measurement assembly is connected with the control assembly in such a way, that sliding the knob generates signals for the control assembly powering the motor actuating the piston, so the piston movement is controlled by the elements of the control assembly.

The Polish patent No. 151372 describes an automatic microprocessor controlled pipette comprising a handle wherein a drive system is mounted consisting of a stepper motor, a feed screw, and a magnetic clutch, and screwable into the housing exchangeable shafts, each of which including a cylinder, a piston and a seal, and of an electronic system to count the electric pulses sent to the stepper motor, and the piston position detector placed on its path. In the handle a sleeve is disposed movably with respect to the handle, and rigidly connected with the stepper motor frame, the sleeve during mounting the shaft to the handle slides into an element, which upper portion is a cylinder slidably mating with the sleeve, while the lower portion is a cylinder wherein the piston is moving. Both cylinders of the element are co-axial, while the piston in its upper end is rigidly joined with a magnetic armature operating with cylindrically shaped magnetic clutch, which bases are the poles of the magnet. Each of the exchangeable shafts has coded information regarding its volume in the form of stripes contrasting with the shaft colour, or in the form of magnetic strips, while an optical or magnetic system is positioned in a recess in the controller housing to read this information.

Further, the Polish patent application No. P.325795 describes a calibration method for a pipette comprising a housing in the form of a handle, and a shaft with a plunger slid by a knob through an adjustment screw, wherein the volume of aspired liquid is set manually by turning the adjustment screw in and out to set the length of the operational stroke of the plunger in the shaft, the position of the adjustment screw is detected, and the signal corresponding to the position of the adjustment screw is sent to an electronic system, in which memory standard aspiration curves are previously stored in the form of a multinominal of n-th degree, and then the signal corresponding to the position of the adjustment screw is compared with one of the aspiration curves, and the position of the adjustment screw is assigned to the value of the aspired volume of liquid which is displayed on the display.

### SUMMARY OF THE INVENTION

According to the present invention, in the method of pipette calibration the volume of the aspired liquid is manually set by turning in and out the adjustment screw regulating the length of the operational stroke of the plunger in the shaft, the position of the adjustment screw is detected, and the signal corresponding to the position of the adjustment screw is sent to the electronic system of the pipette, where the signal corresponding to the position of the adjustment screw is compared with the values of the points from the aspiration table, which is previously input to the memory of the electronic system as the standard aspiration table for the pipette, and next to the position of the adjustment screw, the value of the aspired liquid volume is assigned, and displayed on the display.

Preferably the pipette liquid aspiration tables are assigned to various types of aspirated liquids.

Preferably the values of the aspiration table points depend on the factors influencing the value of the aspired volume of liquid.

Preferably the date of changing the values of the aspiration table points are entered to the electronic system memory and displayed on the display.

According to a variety of the present invention, in the method of pipette calibration the volume of the aspired liquid is manually set by turning in and out the adjustment screw regulating the length of the operational stroke of the plunger in the shaft, the position of the adjustment screw is detected, and the signal corresponding to the position of the adjustment screw is sent to the electronic system of the pipette, where the signal corresponding to the position of the adjustment screw is compared with the values of the points from the aspiration function, which is previously input to the memory of the electronic system as the standard aspiration function for the pipette, and next to the position of the adjustment screw, the value of the aspired liquid volume is assigned, and displayed on the display.

Preferably the pipette liquid aspiration functions are assigned to various types of aspirated liquids.

Preferably the values of the aspiration functions depend on the factors influencing the value of the aspired volume of liquid.

Preferably the date of changing the values of the aspiration functions are entered to the electronic system memory and displayed on the display.

According to another variety of the present invention, in the method of pipette calibration the volume of the aspired liquid is manually set by turning in and out the adjustment screw regulating the length of the operational stroke of the plunger in the shaft, the position of the adjustment screw is detected, and the signal corresponding to the position of the adjustment screw is sent to the electronic system, to the memory of which the standard aspiration curves for the pipette are earlier input, and the signal corresponding to the position of the adjustment screw is compared with one of the aspiration curves, where the signal corresponding to the position of the adjustment screw is converted into the displayed digital value simultaneously with determination of the selected position from the whole range of the adjustment screw positions related to the display of this digital value.

Preferably in the read-out field for the set volume a marker is applied, indicating the direction of adjustment screw position changes in order to reach the selected position by the adjustment.

The advantage of the methods according to the invention is the ease of pipette calibration for various types of liquid and aspiration conditions, and various types of applied tips, with reference to the pipette aspiration table or pipette aspiration function earlier input into the memory of the pipette electronic system, and possibly modified. Moreover the solution according to the invention enhances the accuracy of the set volume for required value displayed on the display, and repeatability of results.

### BRIEF DESCRIPTION OF THE DRAWINGS

The accompanying drawings, which are incorporated in, and form a part of the specification, illustrate embodiments of the present invention and, together with the description, serve to explain the principles of the invention. In the drawings:

FIG. 1 shows longitudinal section of the pipette;

FIG. 2 shows front view of the pipette.

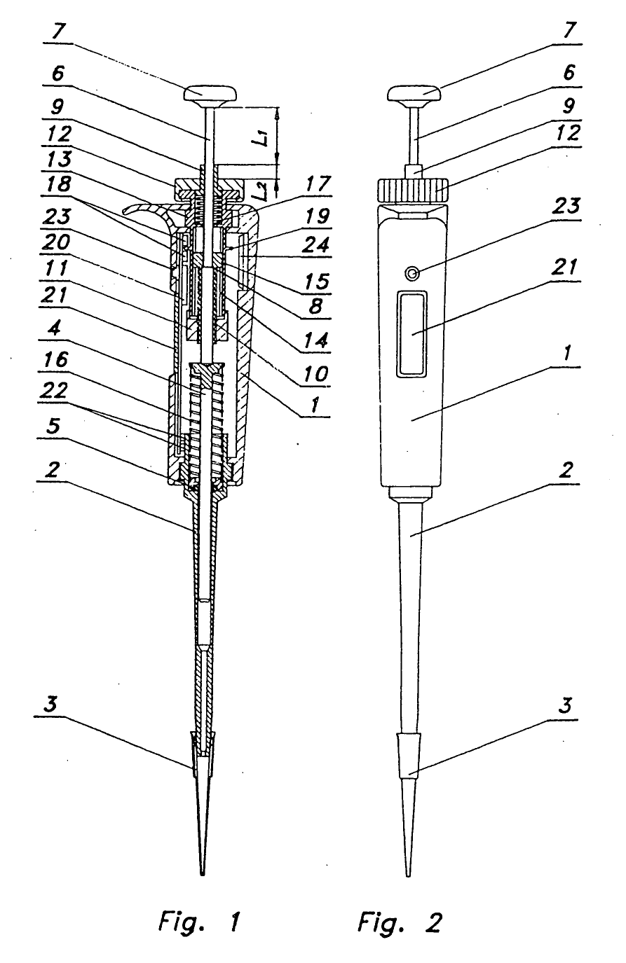

### DETAILED DESCRIPTION OF THE INVENTION

Reference will now be made in detail to the preferred embodiments of the invention, examples of which are illustrated in the accompanying drawings.

The pipette comprising a handle (1) and shaft (2) is assigned for aspirating fluid into a disposable tip (3). A plunger (4) sealed by the means of a seal (5) moves inside the shaft (2). The plunger (4), which is driven by a rod (6) pressed by the button (7) makes reciprocal movements. When the plunger (4) moves upwards, liquid is aspirated to the tip (3), and while the plunger (4) moves downwards, liquid is dispensed from the tip (3). The movements of the rod (6) are limited by two stops, i.e. the upper stop (8) limiting the move upwards, and the lower stop (9) limiting the move downwards. Hence the upper stop (8) constitutes the restriction for the rod (6) in its motion upwards, and the lower stop (9) constitutes the restriction for the button (7) in its motion downwards. The position of the upper stop (8) is adjustable, whereas the adjustment screw (10) is assigned for altering its position. The adjustment screw (10) is turned in or out of the nut (11) which is an element of the handle (1), by the use of the knob (12). Turning the knob (12) causes rotation of the leading sleeve (13). In the hole of the leading sleeve (13) grooves (14) are made, wherein longitudinal cogs (15) disposed on the adjustment screw (10) move during turning the adjustment screw (10) in and out. Change of position of the upper stop (8), which is an element of the adjustment screw (10), results in decreasing or increasing the operational stroke of the plunger (4), hence in the increase or decrease of the volume of liquid aspired into the pipette. The rod (6) is pressed to the upper stop (8) by the return spring (16) which simultaneously causes the return of the plunger (4) to its upper position. In turn, the lower stop (9) is pressed to the knob (12) by the blow-out spring (17).

Aspiration of liquid requires pressing of the button (7) until it abuts against the lower stop (9), insertion of the tip into the liquid being aspired, and releasing the button (7) until the rod (6) abuts against the upper stop (8). A movement on the sector (L₁) will be made. Liquid dispensing requires again re-pressing of the button (7) to the lower stop (9). Again a movement on the sector (L₁) will be made. In order to remove the remainings of the liquid from the tip (3) the lower stop (9) must be pressed by the button (7), overcome the resistance of the blow-out spring (17), and press the button (7) to the knob (12). A movement on the sector (L₂) will be made.

The position of the adjustment screw (10) is monitored by the optical system (18) of the encoder dial (19). The encoder dial (19) is fixed to the leading sleeve (13) and turns simultaneously with the knob (12) and the sleeve (13). The optical system (18) monitors the movements of the encoder dial (19), thanks to what the current position of the adjustment screw (10) and the upper stop (8) is detected. Current position of the adjustment screw (10) in the form of an information on the number of pulses counted by the optical system (18) is transferred to the electronic system (20). The electronic system (20) compares the signal corresponding to the position of the adjustment screw (10) with the values of the points from the standard aspiration table, which ill the form of the standard aspiration table has been earlier input to its memory, assigns to the position of the adjustment screw (10) the value of the liquid being aspirated, and displays it on the display (21). The electronic system (20) automatically selects previously entered into its memory values of the points of the aspiration table with respect to the type of the shaft (2) mounted to the pipette. The signal regarding the type of the shaft (2) is transmitted to the electronic system (20) by the sensors (22).

In case of aspirating liquid of properties other than water, for which a standard aspiration table was input to the memory of the electronic system (20), actual volumes of liquid aspired by the pipette must be determined, and next, by pressing the button (23) and rotating the knob (12), new values must be input to the aspiration table in the electronic system (20), monitoring their appearance of the display (21). After double pressing the button (23) and confirming the new values entered to the memory, the electronic system (20) automatically performs the calibration of the pipette.

In similar way the calibration of the pipette is accomplished in case of change of factors influencing the aspirated amount of liquid, such as type of the tip (3), atmospheric pressure, air humidity, liquid temperature and ambient temperature. Moreover in the memory of the electronic system (20) it is possible to store the date of changing the values of points in the aspiration table, and then display it on the display (21).

The electronic system (20) is powered from a battery (24).

In a variety of the pipette calibration method according to the invention, the electronic system (20) compares the signal corresponding to the position of the adjustment screw (10) with the values of the aspiration function, which in the form of the standard aspiration function has been earlier input to its memory. In this case it is also possible to assign various aspiration functions to various types of aspirated liquids, to relate the aspiration function values to factors influencing the value of the aspired volume of liquid, and to input the date of introducing changes to the values of the aspiration function to the memory of the electronic system (20) and display it on the display (21).

In yet another variety of the pipette calibration method according to the invention, which may constitute a development of the calibration methods described above, the volume of the liquid being aspirated is set in the pipette manually by turning in and out the adjustment screw (10) regulating-the length of the operational stroke of the plunger (4) in the shaft (2). Next, after determination of the position of the adjustment screw (10), an electric signal in the form of electric pulses corresponding to the position of the adjustment screw (10) is sent to the electronic system (20), to which memory earlier standard aspiration curves have been input preferably in the form of a multinominal of n-th degree, and the signal corresponding to the adjustment screw (10) position is compared to one of the aspiration curves. In case when to the same value displayed on the display (21) correspond few electric pulses sent to the electronic system (20), the electronic pulses defining the position of the adjustment screw (10) are converted in the electronic system (20) into digital value displayed of the display (21). The conversion occurs simultaneously with determination of the selected position from the whole range of the adjustment screw (10) positions related to the display of this digital value.

The read-out of the set liquid volume value on the display (21) of the pipette depends on the number of electric pulses counted in the electronic system (20), taking into account the correction for calibration. This correction takes into account, according to the invention, the type of the shaft (2) applied in the pipette, and the distance of intersection of the aspiration curve with the axis of pulses. Moreover, a correction for the determined range of pulses is taken into account in read-out, when the whole range of the pipette aspiration capability is divided into sub-ranges, and it is possible to introduce an individual correction for each range of the counted pulses. It is also possible to introduce additional corrections resulting from temporary calibration. This way the calculated volume corresponds to the displayed value, since there is unique assignment of the given value to the selected pulse from the range of this value.

According to the invention, in the read-out field for the set volume a marker is applied, indicating the direction of adjustment screw (10) position changes in order to reach the selected position by the adjustment screw. Denotation of values is accomplished by blinking of the last digits in case of displaying a value, which is not denoted, and lack of blinking for denoted values. Markers for increase and decrease may be displayed after the last digit of the symbol at the top of the digit for increase, and at the bottom of the digit for decrease.

We claim:

1. The method of pipette calibration, the pipette comprising a body in the form of a handle and a shaft, wherein a plunger slid by a knob through an adjustment screw is placed, wherein the volume of the aspired liquid is manually set by turning in and out the adjustment screw regulating the length of the operational stroke of the plunger in the shaft, the position of the adjustment screw is detected, and the signal corresponding to the position of the adjustment screw is sent to the electronic system of the pipette characterised by that the signal corresponding to the position of the adjustment screw is compared with the values of the points from the aspiration table, which is previously input to the memory of the electronic system as the standard aspiration table for the pipette, and next to the position of the adjustment screw, the value of the aspired liquid volume is assigned, and displayed on the display.

2. The method according to the claim 1 characterised by that the pipette liquid aspiration tables are assigned to various types of aspirated liquids.

3. The method according to the claim 1 characterised by that the values of the aspiration table points depend on the factors influencing the value of the aspired volume of liquid.

4. The method according to the claim 1 characterised by that the date of changing the values of the aspiration table points are entered to the electronic system memory and displayed on the display.

5. The method of pipette calibration, the pipette comprising a body in the form of a handle and a shaft, wherein a plunger slid by a knob through an adjustment screw is placed, wherein the volume of the aspired liquid is manually set by turning in and out the adjustment screw regulating the length of the operational stroke of the plunger in the shaft, the position of the adjustment screw is detected, and the signal corresponding to the position of the adjustment screw is sent to the electronic system of the pipette characterised by that the signal corresponding to the position of the adjustment screw is compared with the values of the points from the aspiration function, which is previously input to the memory of the electronic system as the standard aspiration function for the pipette, and next to the position of the adjustment screw, the value of the aspired liquid volume is assigned, and displayed on the display.

6. The method according to the claim 5 characterised by that the pipette liquid aspiration functions are assigned to various types of aspirated liquids.

7. The method according to the claim 5 characterised by that the values of the aspiration functions depend on the factors influencing the value of the aspired volume of liquid.

8. The method according to the claim 5 characterised by that the date of changing the values of the aspiration functions are entered to the electronic system memory and displayed on the display.

9. The method of pipette calibration, the pipette comprising a body in the form of a handle and a shaft, wherein a plunger slid by a knob through an adjustment screw is placed, wherein the volume of the aspired liquid is manually set by turning in and out the adjustment screw regulating the length of the operational stroke of the plunger in the shaft, the position of the adjustment screw is detected, and the signal corresponding to the position of the adjustment screw is sent to the electronic system, to the memory of which the standard aspiration curves for the pipette are earlier input, and the signal corresponding to the position of the adjustment screw is compared with one of the aspiration curves, characterised by that the signal corresponding to the position of the adjustment screw is converted into the displayed digital value simultaneously with determination of the selected position from the whole range of the adjustment screw positions related to the display of this digital value.

10. The method according to the claim 9 characterised by that in the read-out field for the set volume a marker is applied, indicating the direction of adjustment screw position changes in order to reach the selected position by the adjustment.
